(19) United States
(12) Patent Application Publication
(10) Pub. No.: US 2003/0219203 A1
(43) Pub. Date: Nov. 27, 2003

(54) Multi-channel collimating device

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/295,555

(22) Filed: Nov. 14, 2002

(30) Foreign Application Priority Data
May 24, 2002 (TW) 91207526

(51) Int. Cl. G02B 6/32; G06F 17/30; G06F 7/00

(52) U.S. Cl. 385/33; 707/8

(57) ABSTRACT

A multi-channel collimating device includes an input device and an output device. The input device includes a plurality of input optical fibers, an input fiber receiving device defining a first space to receive said input fibers, a first lens adapted for collimating input light rays from said input fibers. The output device includes a plurality of output optical fibers, an output fiber receiving device defining a second space to receive said output fibers, a second lens for focusing the collimated input light rays from the first lens into said output fibers. The first and second lenses are positioned between the input and output fiber receiving devices. During operation, the input light rays from the input fibers are changed into parallel light rays by passing through the first lens. Then the second lens focuses the parallel light rays into the corresponding output fibers. Thus a multi-channel collimation is attained.

### FIELD OF THE INVENTION

The present invention relates to multi-channel collimating devices, and particularly to a compact multi-channel collimating device.

### BACKGROUND OF THE INVENTION

An optical system called a “collimator” is used in various devices for optical information transmission. In a collimator, divergent beams emitted from one optical fiber are collimated (bent parallel) by one lens to thereby generate a collimated beam; and the collimated beam propagates and then is focused by a second lens to couple the condensed beam with a second optical fiber. Various optical elements, such as filters, optical isolators, optical switches, or beam modulators, can be positioned between the two lenses, thereby forming a variety of different optical modules.

To transmit multi-channel optical information, a lenses array is used instead of a single lens to form a “multi-channel collimator”. Referring to FIG. 5, U.S. patent application Ser. No. 09/968,841 discloses a multi-channel collimator 1 having a first lens assembly 10 and a second lens assembly 12. The first lens assembly 10 has a substrate 14, a lens array 13 fixed onto the substrate 14, and a plurality of optical fibers 16. The lens array 13 comprises a plurality of lenses 15 which are aligned with the optical fibers 16 so that the fibers 16 are coincident with the optical axes of the respective lenses 15. The lenses 15 are arranged at intervals, spaced a predetermined distance apart, on the substrate 14. The second lens assembly 12 is identical to the first lens assembly 10 and comprises a substrate 14′, a lens array 13′ consisting of a plurality of lenses 15′ and a plurality of optical fibers 16′. In each pair of lenses 15, 15′, the lenses 15, 15′ oppose each other and their axes are coincident with each other.

During operation, light rays from a plurality of optical fibers 16 are input the lenses 15, which collimates the light rays into parallel light rays. These parallel light rays are coupled into the lenses 15′ through the lenses 15 and are then output through the optical fibers 16′. The collimated light rays between the lenses 15, 15′ can be transmitted through a plurality of optical components arranged between the lenses 15, 15′ to satisfy different optical needs. More channels can be collimated by adding more pairs of collimating lenses and optical fibers.

However, the collimator 1 uses too many optical components, such as collimating lenses, to attain multi-channel collimation. This results in the collimator taking up a large volume, which is counter to the need for compact assemblies. In addition, manufacturing such collimator is relatively difficult and such a collimator is costly due to the difficulty of manufacture and the large number of optical components.

Therefore, an improved, multi-channel collimating device that overcomes the above-mentioned disadvantages is desired.

### SUMMARY OF THE INVENTION

A main object of the present invention is to provide a cheap multi-channel collimating device which has a compact structure.

To achieve the above object, a multi-channel collimating device according to the present invention includes an input device and an output device. The input device includes a plurality of input optical fibers, an input fiber receiving device defining a first space to receive said input optical fibers, a first lens adapted for collimating input light rays from said input optical fibers. The output device comprises a plurality of output optical fibers, an output fiber receiving device defining a second space to receive said output optical fibers, a second lens for focusing the collimated input light rays from the first lens into said output optical fibers. The first and second lenses are positioned between the input and output fiber receiving devices. During operation, the input light rays from the input fibers are changed into parallel light rays by passing through the first lens. Then the second lens focuses the parallel light rays into the corresponding output fibers. Thus a multi-channel collimation is attained.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a cross-sectional view of a multi-channel collimating device according to a first embodiment of the present invention;

FIG. 2 is a cross-sectional view of an input fiber holder of the multi-channel collimating device of FIG. 1 without an outer ferrule;

FIG. 3 is a cross-sectional view of a multi-channel collimating device according to a second embodiment of the present invention;

FIG. 4 is a cross-sectional view of an assembly of a core with an outer sleeve of the collimating device of FIG. 3; and

FIG. 5 is a perspective view of a multi-channel collimating device of prior art.

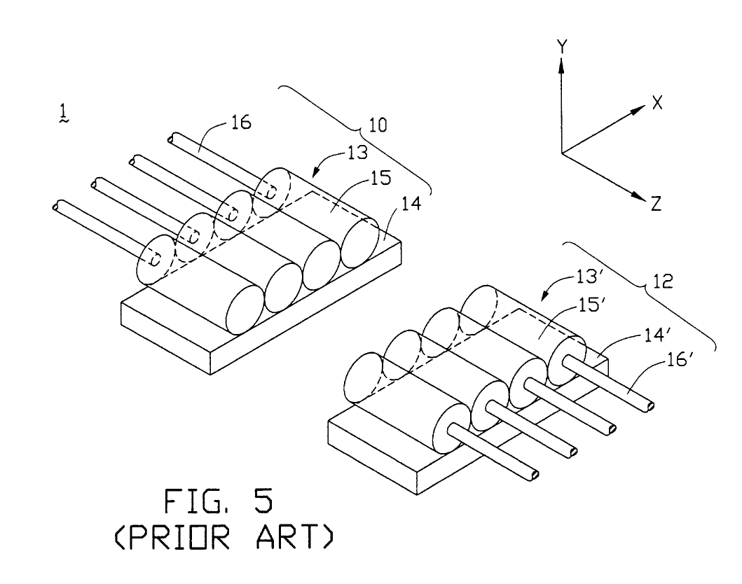

### DETAILED DESCRIPTION OF THE INVENTION

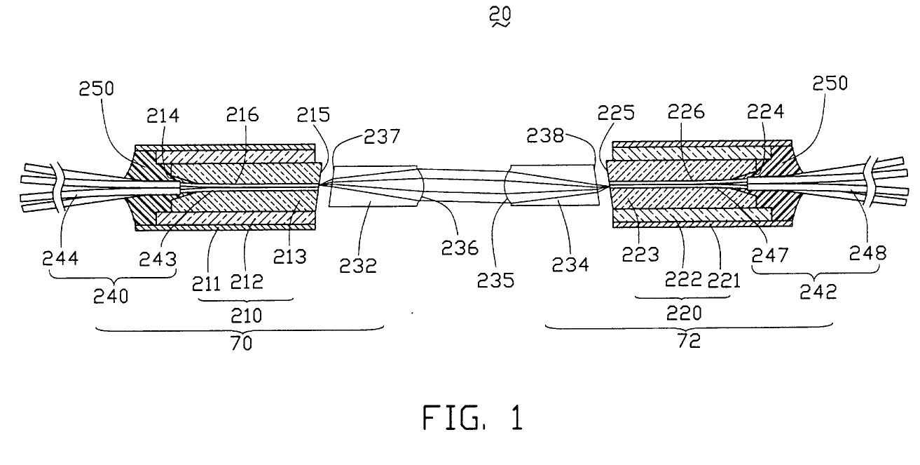

Referring now to the drawings in detail, FIG. 1 shows a multi-channel collimating device 20 in accordance with a first preferred embodiment of the present invention. The multi-channel collimating device 20 comprises an input device 70 and an output device 72.

The input device 70 comprises a plurality of input fibers 240, an input fiber holder 210, and a first lens 232. Each input fiber 240 has a bare portion 243 and a jacketed portion 244. The input fiber holder 210 comprises an outer sleeve 211, an inner sleeve 212 and a ferrule 213 defining a passageway 216 along a longitudinal axis thereof. The input fibers 240 are received in the passageway 216 of the ferrule 213. The ferrule 213 is assembled in the inner sleeve 212 and then the outer sleeve 211 is engaged around the inner sleeve 212 to form the input fiber holder 210. The first lens 232 comprises a non-spherical end face 236 and a sloped end face 237.

The ferrules 213 has a cylindrical shape and define a conical opening 214 in a rear end thereof for easily inserting the bare portions 243 of the input 240. A sloped end face 215 is formed on a front end thereof, the end face 215 making an angle with a plane constructed perpendicular to the axis of the passageway 216. The sloped end face 215 protrudes from a forward end of the inner sleeve 212 and is parallel to the sloped end face 237 of the first lens 232.

The output device 72 has a same structure as the input device 70, includes a plurality of output fibers 242 each having a bare portion 247 and a jacketed portion 248, an output fiber holder 220, and a second lens 234 having a non-spherical end face 235 and a sloped end face 238. The output fiber holder 220 has an outer sleeve 221, an inner sleeve 222 and a ferrule 223 defining a passageway 226 along a longitudinal axis thereof. In the present invention, spaces defined among the input or output fibers 240, 242 and the passageways 216, 226 between the inner and outer sleeves 212, 222, 211, 221 and between the inner sleeves 212, 222 and the ferrules 213, 223 are filled with a kind of glue 250 to secure the various components firmly together.

The first and second lenses 232, 234 are positioned between the input and output fiber holders 210, 220 and the two non-spherical end faces 236, 235 are opposite to each other and the two sloped end faces 237, 238 are opposite to the input and output fiber holders 210, 220, respectively.

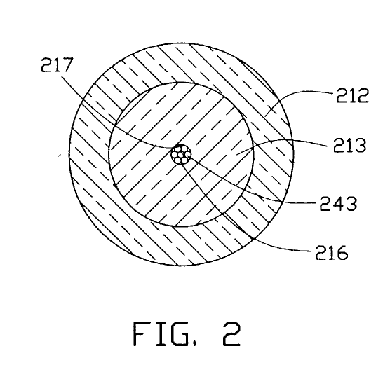

FIG. 2 is a cross-sectional view to show the input fiber holder 210 of the multi-channel collimating device 20 without the outer sleeve 211. The passageway 216 of the ferrule 213 has a cylindrical outer surface 217. The bare portions 243 of the input fibers 240 which are adjacent the outer surface are not constrained to particular, individual positions in the passageway 216 regularly.

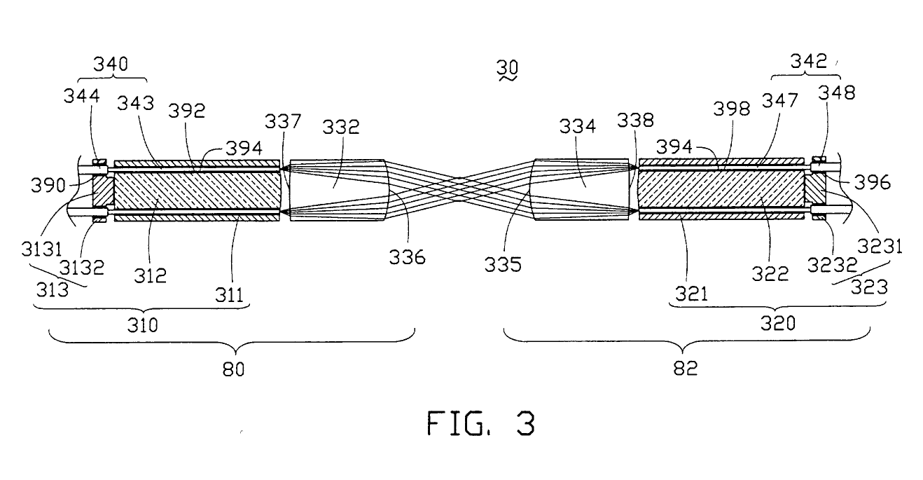

FIG. 3 shows a multi-channel collimating device 30 according to a second embodiment of the present invention, comprises an input device 80 and an output device 82.

The input device 80 comprises an input fiber holder 310, a plurality of input fibers 340 and a first lens 332. Each of the input fibers 340 has a bare portion 343 and a jacketed portion 344. The input fiber holder 310 has an outer sleeve 311, a core 312 and a rear holder 313. The rear holder 313 comprises a central support portion 3131 and a ring 3132 fitting around the support portion 3131. An annular-shaped channel 390 is formed between the support portion 3131 and the ring 3132 for accommodating the jacketed portions 344 of the input fibers 340 therein. The core 312 is assembled in the outer sleeve 311 to form an annular passageway 392 which aligns with the channel 390. The support portion 3131 can be integrally formed with the core 312, or if can be soldered or glued to the core 312. The bare portion 343 is received in the passageway 392 and the jacketed portion 344 is held in the channel 390 to protect the input fibers 340 from damaged. The first lens 332 comprises a non-spherical end face 336 and a curved end face 337.

The output device 82 has a same structure as the input device 80, which comprises an output fiber holder 320, a second lens 334 having a non-spherical end face 336 and a curved end face 337, and a plurality of output fibers 342 each having a bare portion 347 and a jacketed portion 348. The output fiber holder 320 has an outer sleeve 321, a core 322 and a rear holder 323 having a central support portion 3231 and a ring 3232 fitting around the support portion 3131 to define a channel 396 for receiving the jacketed portions 348 of the output fibers 342. The core 322 is assembled in the outer sleeve 321 to form a passageway 398 to receive the bare portions 347 of the output fibers 342.

The first and second lenses 332, 334 are positioned between the input and output fiber holders 310, 320. The two non-spherical end faces 336, 335 are opposite to each other and the two curved end faces 337, 338 are opposite to the input and output fiber holders 310, 320, respectively. In the present invention, spaces defined among the input or output fibers 340, 342, the passageways 392, 398 between the cores 312, 322 and the outer sleeves 311, 321 and the channels 390, 396 between the central support portions 3131, 3231 and the rings 3132, 3232 are filled with a kind of glue 394 to secure the various components firmly together.

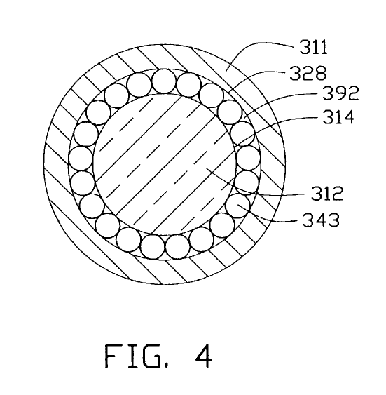

FIG. 4 is a cross-sectional view to show an assembly of the core 312 and the outer sleeve 311. The core 312 has a cylindrical outer surface 314 and the outer sleeve 311 has a cylindrical inner surface 328. The bare portions 343 of the input fibers 340 are arranged in the passageway 392 defined between the core 312 and the outer sleeve 311.

FIG. 1 illustrates a light path through the multi-channel collimating device 20 according to the first embodiment of the present invention. The light rays from the bare portions 243 of the input fibers 240 are changed into parallel light rays by passing through the first lens 232. The second lens 234 focuses the parallel light rays into the corresponding bare portions 247 of the output fibers 242. Thus a multi-channel collimation is attained. FIG. 3 illustrates a light path through the multi-channel collimating device 30 according to the second embodiment of the present invention. The light rays from the bare portions 343 of the input fibers 340 are changed into parallel light rays by passing through the first lens 332. The second lens 334 focuses the parallel light rays into the corresponding bare portions 347 of the output fibers 342 to finish a multi-channel collimation.

Since the multi-channel collimating devices of the present invention combine a plurality of optical fibers in a single ferrule or fiber holder, only one pair of lenses is required to attain the multi-channel collimating capacity attained by a prior art collimator having many lenses. Therefore, the present invention not only provides a compact collimating device, but also lowers optical signals losses. Additionally, the cost to manufacture is lowered since the number of lenses required is lowered and the manufacturing process is simplified. As will be apparent to one skilled in the art, the lenses used in the present invention are not confined to molded lenses, but can instead be other lenses having a collimating function, such as GRIN lens.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A multi-channel collimating device comprising:
an input device having a plurality of input optical fibers, an input fiber receiving device defining a first space to receive said input optical fibers, a first lens adapted for collimating input light rays from said input optical fibers; and
an output device having a plurality of output optical fibers, an output fiber receiving device defining a second space to receive said output optical fibers, a second lens for focusing the collimated input light rays from the first lens into said output optical fibers; wherein
the first and second lenses are positioned between the input and output fiber receiving devices.

2. The multi-channel collimating device of claim 1, wherein each of the input and output fiber receiving devices is a ferrule defining a passageway along a longitudinal axis thereof to receive said input or output optical fibers.

3. The multi-channel collimating device of claim 2, wherein each of the input and output fiber receiving devices further includes an outer sleeve and an inner sleeve, said ferrule is assembled in the inner sleeve and then the outer sleeve is engaged around the inner sleeve.

4. The multi-channel collimating device of claim 1, wherein each of the input and output fiber receiving devices comprises a core and an outer sleeve; the core is assembled in the outer sleeve to form an annular passageway to receive said input or output optical fibers.

5. The multi-channel collimating device of claim 4, wherein each of the input and output fiber receiving devices further comprises a rear holder, the rear holder comprises a central support portion and a ring fitting around the support portion to form an annular-shaped channel for accommodating said input or output optical fibers.

6. The multi-channel collimating device of claim 5, wherein the support portions connect with the corresponding cores and the channels are aligned with the corresponding passageways.

7. The multi-channel collimating device of claim 1, wherein each of said first lenses is able to decollimate more than one light beams from more than one input optical fibers, respectively, and each of said second lenses is able to collimate more than one light beams toward more than one output optical fibers, respectively.

8. A multi-channel collimating device comprising:
an input device having a plurality of input optical fibers, an input fiber holder defining a first passageway along a longitudinal axis thereof to receive said input optical fibers, a first lens adapted for collimating input light rays from said input optical fibers; and
an output device having a plurality of output optical fibers, an output fiber holder defining a second passageway along a longitudinal axis thereof to receive said output optical fibers, a second lens for focusing the collimated input light rays from the first lens into said output optical fibers; wherein
the first and second lenses are positioned between the input and output fiber holders.

9. The multi-channel collimating device of claim 8, wherein each of the input and output fiber holders comprises an outer sleeve, an inner sleeve and a ferrule, said first passageway is formed in the ferrule along a longitudinal axis thereof.

10. The multi-channel collimating device of claim 9, wherein each ferrule of the input and output fiber holders is assembled in the corresponding inner sleeve and then the corresponding outer sleeve is engaged around the corresponding inner sleeve to form the input or output fiber holder.

11. The multi-channel collimating device of claim 8, wherein each of the input and output optical fibers has a bare portion and a coated portion.

12. The multi-channel collimating device of claim 11, wherein the first and second passageways substantially receive the bare portions of the input and output optical fibers, respectively.

13. The multi-channel collimating device of claim 10, wherein the first and second lenses each comprises a non-spherical end face and a sloped end face, and the two non-spherical end faces are opposite to each other and the two sloped end faces are opposite to the input and output fiber holders, respectively.

14. The multi-channel collimating device of claim 10, wherein spaces defined among the input or output fibers and the passageways between the inner and outer sleeves and between the inner sleeve and the ferrule are filled with a kind of glue to secure the various components firmly together.

15. A multi-channel collimating device comprising:
an input device having a plurality of input optical fibers, an input fiber holder comprising a first outer sleeve and a first core assembled therein to form an first annular passageway to receive said input optical fibers, a first lens adapted for collimating input light rays from said input optical fibers; and
an output device having a plurality of output optical fibers, an output fiber holder comprising a second outer sleeve and a second core assembled therein to form an second annular passageway to receive said output optical fibers, a second lens for focusing the collimated input light rays from the first lens into said output optical fibers; wherein
the first and second lenses are positioned between the input and output fiber holders.

16. The multi-channel collimating device of claim 15, wherein each of the input and output optical fibers has a bare portion and a coated portion.

17. The multi-channel collimating device of claim 16, wherein each of the input and output fiber holder further includes a rear holder, the rear holder comprises a central support portion and a ring fitting around the support portion to form an annular-shaped channel for accommodating the jacketed portions of the input or output fibers therein.

18. The multi-channel collimating device of claim 17, the support portions connects with the corresponding cores and the annular passageways are aligned with the corresponding annular shaped channels, the bare portions are received in the corresponding passageways and the jacketed portions are held in the corresponding channels to protect the input and output fibers from damaged.

19. The multi-channel collimating device of claim 17, wherein the first and second lenses each comprises a non-spherical end face and a curved end face, and the two non-spherical end faces are opposite to each other and the two curved end faces are opposite to the input and output fiber holders, respectively.

20. The multi-channel collimating device of claim 18, wherein spaces defined among the input or output optical fibers, the passageways between the cores and the outer sleeves and the channels between the central support portions and the rings are filled with a kind of glue to secure the various components firmly together.
